(19) United States
(12) Patent Application Publication
(10) Pub. No.: US 2025/0258635 A1
(43) Pub. Date: Aug. 14, 2025

(54) PRINTING APPARATUS AND METHOD FOR CONTROLLING PRINTING APPARATUS

(71) Applicant: CANON KABUSHIKI KAISHA, Tokyo (JP)

(72) Inventor: AKIYOSHI SAHARA, Chiba (JP)

(21) Appl. No.: 19/049,434

(22) Filed: Feb. 10, 2025

(30) Foreign Application Priority Data
Feb. 14, 2024 (JP) 2024-019941

(51) Int. Cl. G06F 3/12; B41J 2/175; B41J 29/00

(52) U.S. Cl. CPC G06F 3/1294; B41J 2/17543; B41J 29/00

(57) ABSTRACT

A method for controlling a printing apparatus having an attached consumable includes reading identification information on the consumable and history information indicating whether delivery processing has been executed by a predetermined service for the consumable identified by the identification information, and storing the identification information and the history information of the printing apparatus, transmitting a request for relating information on the predetermined service for the consumable to a server system, and receiving the relating information on the predetermined service in response to the request. The request is not transmitted in a case where the history information includes a delivery history indicating that delivery processing has been executed by the predetermined service, and the request is transmitted in a case where the history information in association with the identification information on the consumable indicates that the delivery processing has not been executed by the predetermined service.

### BACKGROUND

### Field

The present disclosure relates to a printing apparatus and a method for controlling a printing apparatus.

### Description of the Related Art

A system that utilizes a server to manage automatic delivery of consumables for a printing apparatus has been known. Japanese Patent Laid-Open No. 2022-140056 discloses a technique in which a management server determines whether a consumable attached to a printing apparatus is a target of automatic delivery.

If the entire determination of whether a consumable is a target of automatic delivery is performed by the server, the server becomes heavily loaded.

### SUMMARY

According to an aspect of the present disclosure, a printing apparatus includes a first processing unit configured to execute first processing for reading, from a first storage unit of a consumable attached to the printing apparatus, identification information on the consumable and history information indicating whether delivery processing has been executed by a predetermined service for the consumable identified by the identification information, and storing the identification information and the history information in a second storage unit of the printing apparatus, a requesting unit configured to request relating information on the predetermined service for the consumable attached to the printing apparatus to a server system that provides the predetermined service, and a reception unit configured to receive the relating information on the predetermined service transmitted from the server system in response to the request, wherein the request is not transmitted in a case where the history information includes a delivery history indicating that delivery processing has been executed by the predetermined service, and the request is transmitted in a case where the history information stored in the second storage unit in association with the identification information on the consumable attached to the printing apparatus indicates that the delivery processing has not been executed by the predetermined service.

Further features of the present disclosure will become apparent from the following description of exemplary embodiments with reference to the attached drawings.

### BRIEF DESCRIPTION OF THE DRAWINGS

FIG. 1 is a diagram illustrating an example configuration of a consumable management system according to the present exemplary embodiment.

FIG. 2 is a diagram schematically illustrating an example operation form of a service using the consumable management system.

FIG. 3A is a diagram illustrating a hardware configuration example of an image forming apparatus according to the present exemplary embodiment, and FIG. 3B is a diagram illustrating a connection form between a consumable attachment unit and ink cartridges according to the present exemplary embodiment.

FIG. 4 is a block diagram illustrating a hardware configuration example of a management server.

FIGS. 5A to 5C are flowcharts each illustrating a control example of the management server.

FIGS. 6A to 6D are flowcharts each illustrating a control example of the image forming apparatus according to the present exemplary embodiment.

FIGS. 7A to 7D are diagrams each illustrating a configuration example of data stored in a storage unit of the image forming apparatus according to the present exemplary embodiment.

FIG. 8 is a flowchart illustrating an example of cartridge recognition processing of the image forming apparatus according to the present exemplary embodiment.

FIG. 9 is a flowchart illustrating an example of type determination request processing of the image forming apparatus according to the present exemplary embodiment.

FIG. 10 is a flowchart illustrating an example of delivery determination request processing of the image forming apparatus according to the present exemplary embodiment.

### DESCRIPTION OF THE EMBODIMENTS

Hereinafter, an exemplary embodiment will be described in detail with reference to the accompanying drawings. The exemplary embodiments do not limit the disclosure according to the appended claims. Although a plurality of features are described in the exemplary embodiments, all of the plurality of features are not necessarily essential to the disclosure, and the plurality of features may be arbitrarily combined. In the accompanying drawings, the same or similar components are denoted by the same reference numerals, and the redundant description will be omitted.

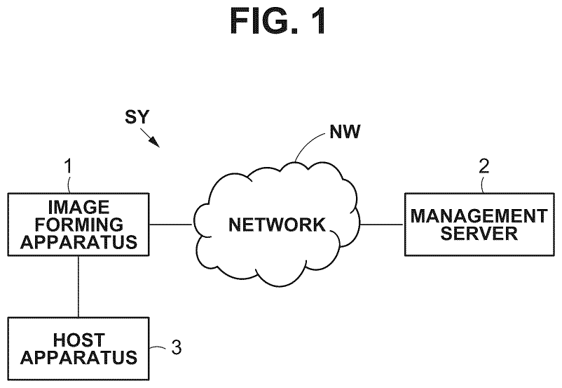

FIG. 1 illustrates an example configuration of a consumable management system SY according to an exemplary embodiment of the present disclosure.

The consumable management system SY includes an image forming apparatus 1, a management server 2, and a host apparatus 3. The image forming apparatus 1 and the host apparatus 3 are installed in a user's office and communicably connected with each other via a wired or wireless Local Area Network (LAN).

The management server 2 is installed in the office of a provider of an automatic consumable delivery service (described below) and serves as one of servers included in a server system for providing the automatic consumable delivery service. The management server 2 connects with the image forming apparatus 1 via a network NW, such as the Internet.

The communication method with the network NW (described below) is an example, and other communication methods are also suitably applicable.

The image forming apparatus 1 is a printer serving as an example of a printing apparatus according to the present exemplary embodiment. The image forming apparatus 1 receives print job data including image data from the host apparatus 3 and records (prints) an image on a recording medium, such as paper, based on the received data. The image forming apparatus 1 may be a Multifunction Peripheral (MFP) having a scanner and may record an image based on image data of a document read by the scanner. In the present exemplary embodiment, the image forming apparatus 1 is an inkjet printer that records an image by discharging ink on a recording medium. The recording method of the image forming apparatus 1 is not limited thereto, and the image forming apparatus may be, for example, an electrophotographic printer. Main consumables as targets of the delivery service according to the present exemplary embodiment are recording agent containers. Specific examples of consumables include ink cartridges, ink tanks, ink bottles, toner bottles, and toner cartridges. A recording agent container includes a memory to which read and write operations are performed under the control of the central processing unit (CPU) of the image forming apparatus 1 in a state where the container is attached to the image forming apparatus 1.

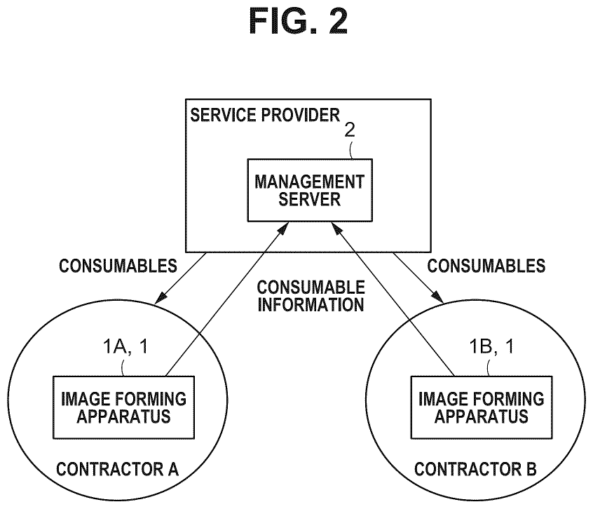

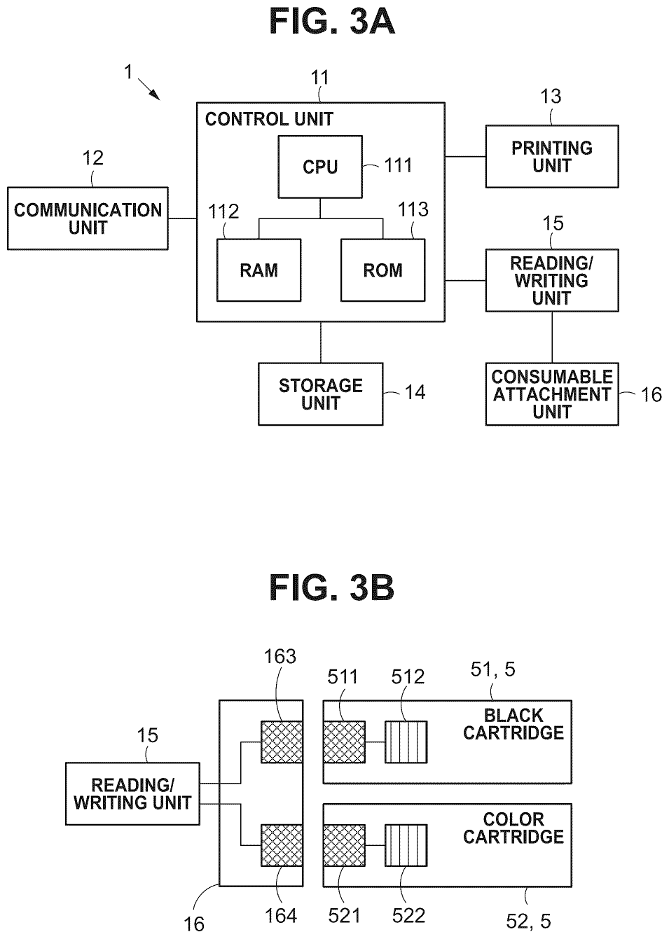

FIG. 2 is a diagram schematically illustrating an example of a service operation form using the consumable management system SY. FIG. 2 schematically illustrates a service operation form example in which the consumable management system SY is used for the automatic consumable delivery service for an ink cartridge 5 (see FIG. 3B) that is an attachment consumable for the image forming apparatus 1.

The image forming apparatus 1 transmits information about a consumable to the management server 2 via the network NW. In response to receipt of the information about the consumable from the image forming apparatus 1, the management server 2 determines whether the consumable is a target of the automatic consumable delivery service. The management server 2 may perform determination of whether to deliver a new consumable (e.g., an ink cartridge 5 illustrated in FIG. 3B), in accordance with the usage status of the consumable. The management server 2 may also determine whether an additional charge is to be applied. The service provider of the automatic consumable delivery service delivers the ink cartridge 5 as a consumable to a contractor, based on the result of the determination of the management server 2. In this operational form, an ink cartridge 5 which is a new one is delivered to the contractor at the time of replacement of the ink cartridge 5 as a consumable. Thus, the contractor can keep using the image forming apparatus 1 without waiting for the delivery of the consumable. The management server 2 connects with a plurality of the image forming apparatus 1 (image forming apparatuses 1A and 1B) and manage the automatic delivery to a plurality of contractors (contractors A and B).

For example, the automatic delivery service may be a fixed monthly payment subscription service which allows contractors to use the ink cartridge 5 automatically delivered without additional charges until the number of sheets printed by the image forming apparatus 1 reaches a predetermined value. The automatic delivery service may also be a usage-based service in which contractors pay charge according to the number of ink cartridges 5 automatically delivered, for example. The service applicable to the present exemplary embodiment is not limited to the automatic delivery service. For example, contractors may be given points according to the number of ink cartridges 5 used by contractors. In this case, points given to contractors may be managed by the management server 2. The consumable includes not only automatically delivered consumables but also consumables individually purchased by users.

FIG. 3A is a block diagram illustrating an example hardware configuration of the image forming apparatus 1.

The image forming apparatus 1 includes a control unit 11, a communication unit 12, a printing unit 13, a storage unit 14, a reading/writing unit 15, and a consumable attachment unit 16. The hardware configuration illustrated in FIG. 3A is an illustrative example and may be suitably changed.

The control unit 11 includes a central processing unit (CPU) 111 for overall control of the image forming apparatus 1, a random access memory (RAM) 112 serving as the main memory for storing temporary data during control, and a read only memory (ROM) 113 for storing control programs.

For example, various functions related to the image forming apparatus 1 are implemented by the CPU 111 reading a program stored in the ROM 113 into the RAM 112 and then executing the program. More specifically, the control unit 11 executes various functions when information processing by the software stored in the ROM 113 is specifically implemented by the CPU 111 as an example of hardware.

At least some of the functions implemented by the control unit 11 may be implemented by a known semiconductor apparatus, such as a programmable logic device (PDL) and an application specific integrated circuit (ASIC). While the control unit 11 is described as a single element, the control unit 11 may be divided into two or more elements as required.

The communication unit 12 is a communication interface between the image forming apparatus 1 and an external apparatus. For example, the control unit 11 receives print job data including image data from the host apparatus 3 via the communication unit 12. The control unit 11 communicates information with the management server 2 via the communication unit 12. While the present exemplary embodiment uses a wireless local area network (LAN) as a mean for connecting the communication unit 12 and the network NW, other communication methods are also applicable.

The printing unit 13 records an image on a recording medium. For example, the control unit 11 instructs the printing unit 13 to record an image based on print job data received from the host apparatus 3 via the communication unit 12.

The storage unit 14 stores various information. For example, the control unit 11 stores information received from the management server 2 in the storage unit 14. According to the present exemplary embodiment, the storage unit 14 includes a flash ROM as a nonvolatile memory. The storage unit 14 may include other storage elements as long as the unit serves as a nonvolatile memory.

The reading/writing unit 15 reads information on the ink cartridges 5 which are consumables attached to the consumable attachment unit 16. The reading/writing unit 15 will be described in detail below with reference to FIG. 3B.

FIG. 3B is a schematic view illustrating an example of a connection form between the consumable attachment unit 16 and the ink cartridges 5. According to the present exemplary embodiment, each of a black cartridge 51 and a color cartridge 52 as examples of the ink cartridges 5 is attachable to and detachable from the consumable attachment unit 16.

When the black cartridge 51 is attached to the consumable attachment unit 16, a connection receptacle 163 of the consumable attachment unit 16 is electrically connected with a connection terminal 511 of the black cartridge 51. In this processing, the control unit 11 controls the reading/writing unit 15 to read information from and write information to a nonvolatile memory 512 of the black cartridge 51. Likewise, when the color cartridge 52 is attached to the consumable attachment unit 16, a connection receptacle 164 is electrically connected with a connection terminal 521. Thus, the control unit 11 controls the reading/writing unit 15 to read information from and write information to a nonvolatile memory 522.

According to the present exemplary embodiment, identification information (hereinafter referred to as a “cartridge identifier (ID)”) for identifying each individual black cartridge 51 is stored as consumable information in the nonvolatile memory 512. The cartridge ID of the color cartridge 52 is stored as the consumable information in the nonvolatile memory 522.

The control unit 11 and the management server 2 use the cartridge ID to identify each individual ink cartridge 5 attached to the image forming apparatus 1. The nonvolatile memories 512 and 522 store history information on the automatic consumable delivery service. The control unit 11 controls the reading/writing unit 15 to read and update the history information.

The number and types of the ink cartridges 5 that are attached to the consumable attachment unit 16 are not limited. For example, the consumable attachment unit 16 may be attached with four different ink cartridges of cyan (C), magenta (M), yellow (Y), and black (K). The consumable attachment unit 16 may be attached with at least two cartridges of the same type (e.g., a plurality of the black cartridges 51).

The reading/writing unit 15 may read the cartridge ID, and read and update the history information on the automatic consumable delivery service in different forms. For example, the ink cartridges 5 may be provided with a bar code or Quick Response (QR) Code (R) including the cartridge ID information, and the reading/writing unit 15 may be a reader for reading these codes. The ink cartridges 5 may also include an integrated circuit (IC) tag, and the reading/writing unit 15 wirelessly communicates with the IC tag to read information stored in the memory in the IC tag and write information to the memory.

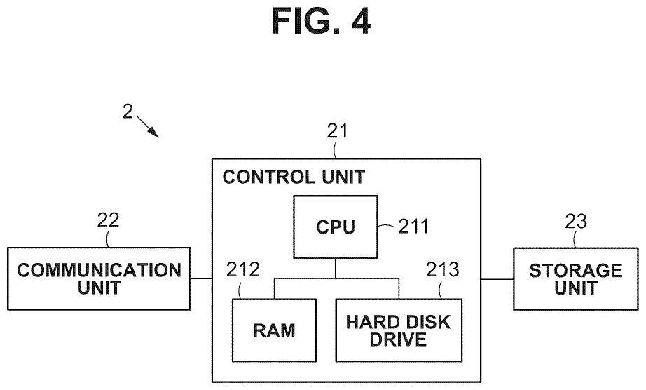

FIG. 4 is a block diagram illustrating an example hardware configuration of the management server 2.

The management server 2 includes a control unit 21, a communication unit 22, and a storage unit 23.

The control unit 21 includes a CPU 211 for overall control of the management server 2, a RAM 212 serving as the main memory for storing temporary data during control, and a hard disk drive (HDD) 213 for storing control programs.

For example, various functions related to the management server 2 are implemented by the CPU 211 reading a program stored in the HDD 213 into the RAM 212 and then executing the program. More specifically, the control unit 21 executes various function when information processing by the software stored in the ROM 113 is specifically implemented by the CPU 111 as an example of hardware. Instead of or together with a hard disk drive (HDD), other memories, such as a solid state drive (SSD) and embedded MultiMedia Card (eMMC) may be provided.

While the management server 2 according to the present exemplary embodiment includes one server apparatus (information processing apparatus), the present exemplary embodiment is not limited thereto. A plurality of server apparatuses on a cloud may be configured to cooperatively operate to implement each function. More specifically, the management server 2 may include a plurality of server apparatuses. According to the present exemplary embodiment, a configuration including one server apparatus or a plurality of server apparatuses is also called a server system.

The communication unit 22 is a communication interface between the management server 2 and an external apparatus. For example, the control unit 21 communicates with a number of the image forming apparatuses 1 via the communication unit 22. While the present exemplary embodiment uses a wired LAN as a mean for connecting the communication unit 22 with the network NW, other communication methods are also applicable.

The storage unit 23 stores various information about the automatic delivery service. While the present exemplary embodiment includes a hard disk drive as the storage unit 23, other forms are also applicable as appropriate.

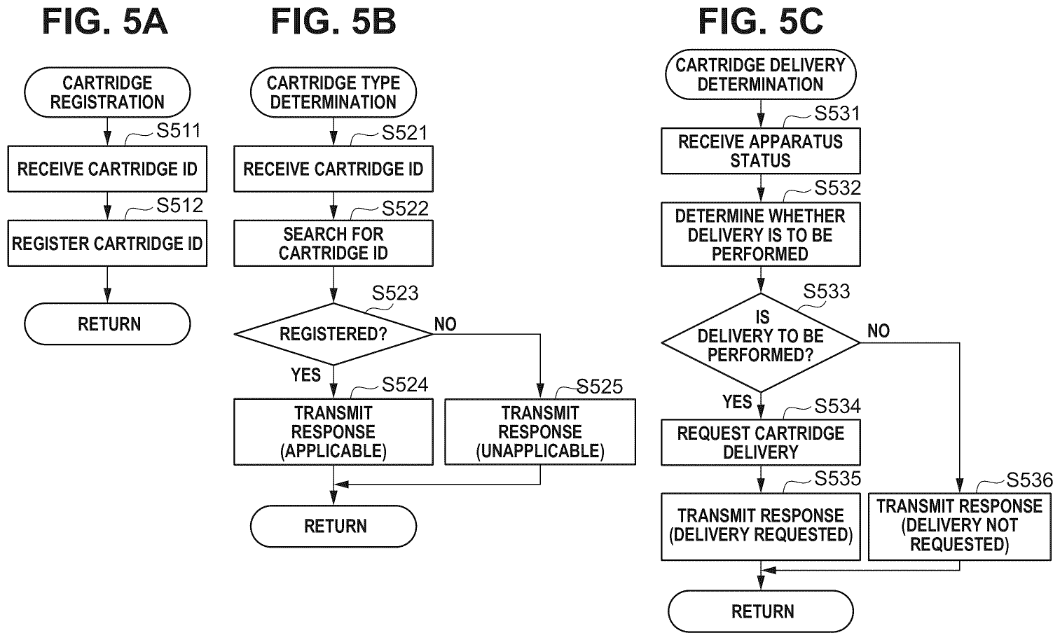

FIGS. 5A to 5C are flowcharts each illustrating an example of control that is performed by the management server 2. The operation of the management server 2 in the automatic consumable delivery service according to the present exemplary embodiment will be described below. The flowcharts in FIGS. 5A to 5C are implemented by the CPU 211 of the control unit 21 of the management server 2 reading a program stored in the hard disk drive 213 into the RAM 212 and then executing the program. In response to the communication unit 22 of the management server 2 receiving a command from the image forming apparatus 1 or another client apparatus (e.g., an information processing apparatus, such as a personal computer), the control unit 21 executes processing corresponding to the command. FIGS. 5A to 5C illustrate processing that is executed by the control unit 21 in response to receipt of different commands.

FIG. 5A is a flowchart illustrating an example of processing (cartridge registration processing) that is performed to pre-register the cartridge ID of an ink cartridge 5 to be delivered to a contractor. The processing of this flowchart is executed by the control unit 21 in response to the communication unit 22 receiving a cartridge registration command. According to the present exemplary embodiment, the cartridge registration command is a command for storing the cartridge ID of the ink cartridge 5 to be automatically delivered to the contractor in the storage unit 23. For example, a cartridge registration command is automatically issued by a cartridge production management server (not illustrated). Alternatively, a cartridge registration command may be manually issued by a cartridge stock manager from any client apparatus.

In step S511, the control unit 21 receives a certain number of cartridge IDs via the communication unit 22.

In step S512, the control unit 21 stores the cartridge ID received in step S511 in the storage unit 23. In this processing, the control unit 21 stores the cartridge ID in association with information about the delivery destination contractor or information about the image forming apparatus 1 that is used by the contractor (identification information on the image forming apparatus 1).

With the above-described processing, the management server 2 stores information on the cartridge that is to be automatically delivered.

In the automatic consumable delivery service, the control unit 21 checks whether an ink cartridge 5 attached to the image forming apparatus 1 of the contractor is an ink cartridge provided by the service (an ink cartridge is the one supported by the service). The management server 2 performs this checking by executing the cartridge registration processing illustrated in FIG. 5A in advance.

FIG. 5B is a flowchart illustrating an example of processing for determination of the type of an ink cartridge 5 attached to the image forming apparatus 1. The processing of this flowchart is executed by the control unit 21 in response to the communication unit 22 receiving a cartridge type determination command issued by the image forming apparatus 1. According to the present exemplary embodiment, the cartridge type determination command is a command for determining whether the cartridge ID of the ink cartridge 5 attached to the image forming apparatus 1 is one stored in the storage unit 23 by the cartridge registration processing as illustrated in FIG. 5A.

In step S521, the control unit 21 receives the cartridge ID of the ink cartridge 5 attached to the image forming apparatus 1 via the communication unit 22 from the image forming apparatus 1. While, according to the present exemplary embodiment, the control unit 21 receives one cartridge ID for each command, the control unit 21 may receive a plurality of cartridge IDs with one command.

In step S522, the control unit 21 searches for the cartridge ID received in step S521. For example, the control unit 21 checks whether the information about the image forming apparatus 1 transmitted the cartridge type determination command and the cartridge ID received in step S521 have been stored in the storage unit 23 in an associated way in the cartridge registration processing in FIG. 5A. In a case where these pieces of information are stored in the storage unit 23 in an associated way, the control unit 21 may recognize that the cartridge ID received in step S521 has been registered.

In step S523, the control unit 21 performs control of branch processing based on the result of the search in step S522. In a case where the cartridge ID has been registered in the storage unit 23 (YES in step S523), the processing proceeds to step S524.

In step S524, the control unit 21 transmits a response indicating that the cartridge is a cartridge as a target of the automatic delivery service (hereinafter referred to as an automatically delivered cartridge) to the image forming apparatus 1 via the communication unit 22. Then, the processing exits this flowchart.

In a case where the cartridge ID is not registered in the storage unit 23 (NO in step S523), the processing proceeds to step S525.

In step S525, the control unit 21 transmits a response indicating that the cartridge is not of an automatically delivered cartridge to the image forming apparatus 1 via the communication unit 22. Then, the processing exits this flowchart.

With the above-described processing, the management server 2 determines whether the ink cartridge 5 attached to the image forming apparatus 1 is an automatically delivered cartridge, and notifies the image forming apparatus 1 of the result of the determination.

FIG. 5C is a flowchart illustrating an example of processing for determination of whether delivering the ink cartridge 5 is to be performed. The processing of this flowchart is executed by the control unit 21 in response to the communication unit 22 receiving a cartridge delivery determination command issued by the image forming apparatus 1.

The cartridge delivery determination command is a command for requesting a delivery of the ink cartridge 5 in accordance with the status of the image forming apparatus 1 or the ink cartridge 5.

In step S531, the control unit 21 receives information about the status of the image forming apparatus 1 from the image forming apparatus 1 via the communication unit 22. The information about the status of the image forming apparatus 1 may include, for example, whether the ink cartridge 5 automatically delivered is attached. The information about the status of the image forming apparatus 1 may also include the remaining amount of ink in the ink cartridge 5 attached to the image forming apparatus 1.

In step S532, the control unit 21 determines whether delivery of the ink cartridge 5 is to be performed with reference to the information about the status of the image forming apparatus 1 received in step S531. For example, in a case where the ink cartridge 5 automatically delivered is attached to the image forming apparatus 1, the remaining amount of ink in the ink cartridge 5 is equal to or less than a predetermined amount, and a delivery request has not been issued, the control unit 21 may determine that delivery of the ink cartridge 5 is to be performed.

In a case where the control unit 21 determines that the delivery of the ink cartridge 5 is not to be performed (NO in step S533), the processing proceeds to step S536.

In step S536, the control unit 21 transmits a response indicating that a delivery request has not been transmitted, to the image forming apparatus 1 via the communication unit 22. Then, the processing exits this flowchart.

In step S533, the control unit 21 performs control of branch processing based on the result of the determination in step S532. In a case where the control unit 21 determines that the delivery of the ink cartridge 5 to be performed (YES in step S533), the processing proceeds to step S534.

In step S534, the control unit 21 transmits information indicating a request to deliver the ink cartridge 5 via the communication unit 22. The transmission destination according to the present exemplary embodiment is a cartridge order management server (not illustrated) that manages, for example, information about consumable delivery destinations and the like. In response to receipt of a delivery request for a delivery of an ink cartridge 5 from the management server 2, the cartridge order management server arranges a delivery of the ink cartridge 5 to the delivery destination of the target contractor. The transmission destination of the information in step S534 is not limited to the cartridge order management server.

In step S535, the control unit 21 transmits a response indicating that the management server 2 has transmitted a delivery request, to the image forming apparatus 1 via the communication unit 22. Then, the processing exits this flowchart.

With the above-described processing, the management server 2 issues an order for a delivery of the ink cartridge 5 to the user of the image forming apparatus 1 on which replacement of the ink cartridge 5 is to be required.

With the operation of the management server 2 illustrated in FIGS. 5A to 5C, the management server 2 sufficiently perform the automatic delivery of the ink cartridge 5 to the user of the image forming apparatus 1 using the automatic delivery service.

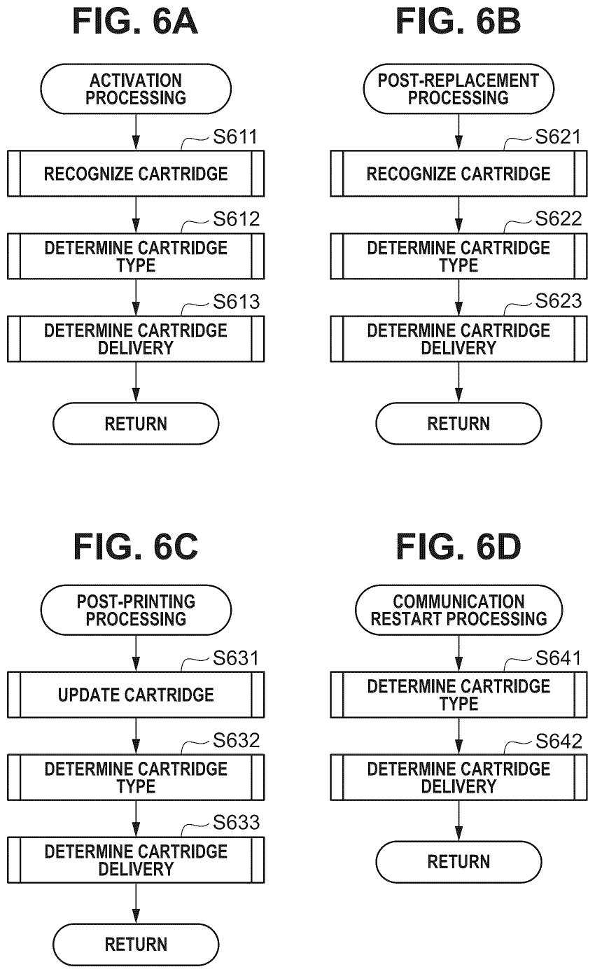

FIGS. 6A to 6D are flowcharts illustrating example control of the image forming apparatus 1. The operation of the image forming apparatus 1 in the automatic consumable delivery service according to the present exemplary embodiment will be described below. For example, the control unit 11 executes the processing illustrated in FIGS. 6A to 6D after the user of the image forming apparatus 1 performs an operation. The processing of the flowcharts in FIGS. 6A to 6D is implemented by the CPU 111 of the control unit 11 of the image forming apparatus 1 reading a program stored in the ROM 113 into the RAM 112 and then executing the program.

FIG. 6A is a flowchart illustrating an example of processing executed by the control unit 11 when the user activates the image forming apparatus 1 with a power-on operation.

In step S611, the control unit 11 performs cartridge recognition processing. In the cartridge recognition processing, the control unit 11 reads the cartridge ID and history information on the automatic consumable delivery service (hereinafter referred to as “automatic delivery history information”) from the ink cartridge 5 attached to the consumable attachment unit 16 via the reading/writing unit 15. This processing will be described in detail below.

In step S612, the control unit 11 performs cartridge type determination processing. According to the present exemplary embodiment, in the cartridge type determination processing, the control unit 11 transmits a cartridge type determination command to the management server 2 as appropriate and receives information about whether the cartridge is a target of an automatically delivered cartridge (hereinafter referred to as “automatic delivery applicability information”) as a response. In this case, the management server 2 executes the flowchart in FIG. 5B. This processing will be described in detail below.

In other words, the automatic delivery applicability information is information about whether an ink cartridge 5 as an example of a consumable is an ink cartridge based on a contract on the use of the image forming apparatus 1 (an ink cartridge as a target of the service). Further, a contract on the use of the image forming apparatus 1 is a contract on the delivery of the ink cartridge 5 as an example of a consumable that is attached to the image forming apparatus 1. In a case of a point application service, in step S612, the control unit 11 receives information indicating whether the ink cartridge 5 is a target of the service with which points are given upon use of the ink cartridge 5, as a response from the management server 2.

In step S613, the control unit 11 performs cartridge delivery determination processing. According to the present exemplary embodiment, in the cartridge delivery determination processing, the control unit 11 transmits a cartridge delivery determination command to the management server 2 to notify the management server 2 of the status of the image forming apparatus 1. The control unit 11 also receives information about whether the management server 2 has transmitted a delivery request, as a response from the management server 2. In this processing, the management server 2 executes the flowchart in FIG. 5C. This processing will be described in detail below.

After completion of step S613, the processing exits this flowchart. The image forming apparatus 1 may be configured to be operated by the user even during execution of the processing in steps S612 and S613.

FIG. 6B is a flowchart illustrating an example of processing that is executed by the control unit 11 when the user replaces the ink cartridge 5 of the image forming apparatus 1, i.e., the user attaches a new one to the consumable attachment unit 16. Processing in steps S621 to S623 is similar to the processing in steps S611 to S613, respectively, and the redundant descriptions will be omitted. The image forming apparatus 1 may be configured to be operated by the user even during execution of the processing in steps S622 and S623.

FIG. 6C is a flowchart illustrating an example of processing to be executed by the control unit 11 after the image forming apparatus 1 receives image data from the host apparatus 3, and the printing unit 13 records an image in a recording medium.

In step S631, the control unit 11 performs cartridge update processing. According to the present exemplary embodiment, in the cartridge update processing, the control unit 11 updates the automatic delivery history information stored in the ink cartridge 5 attached to the consumable attachment unit 16 via the reading/writing unit 15.

The attachment condition of the ink cartridge 5 in the consumable attachment unit 16 remains unchanged when the control unit 11 executes the processing in FIG. 6C. Thus, the cartridge recognition processing of step S611 in FIG. 6A is skipped. Processing in steps S632 and S633 is similar to the processing in steps S612 and S613, respectively, and the redundant descriptions will be omitted. Even during execution of the processing illustrated in FIG. 6C, the image forming apparatus 1 receives image data from the host apparatus 3 and performs image recording on a recording medium via the printing unit 13.

FIG. 6D is a flowchart illustrating an example of processing that is executed by the control unit 11 when communication with the management server 2, once disabled after the activation of the image forming apparatus 1, is enabled again. Examples causing incommunicable state between the image forming apparatus 1 and the management server 2 include a temporary disconnection of the wireless LAN between the communication unit 12 and the network NW. Processing in step S641 and S642 is similar to the processing in steps S612 and S613, respectively, and the redundant descriptions will be omitted.

Since the attachment condition of the ink cartridge 5 in the consumable attachment unit 16 remains unchanged while the control unit 11 executes the processing in FIG. 6D, the cartridge recognition processing of step S611 in FIG. 6A is skipped. Even during execution of the processing illustrated in FIG. 6D, the image forming apparatus 1 receives image data from the host apparatus 3 and performs image recording on a recording medium via the printing unit 13. The processing illustrated in FIG. 6D is executed when the image forming apparatus 1 shifts from an incommunicable state to a communicable state with the management server 2 while the image forming apparatus 1 itself is activated. Thus, when communication between the image forming apparatus 1 and the management server 2 becomes available in the operation mode of the image forming apparatus 1 (power is ON), the control unit 11 executes the processing of the flowchart illustrated in FIG. 6A.

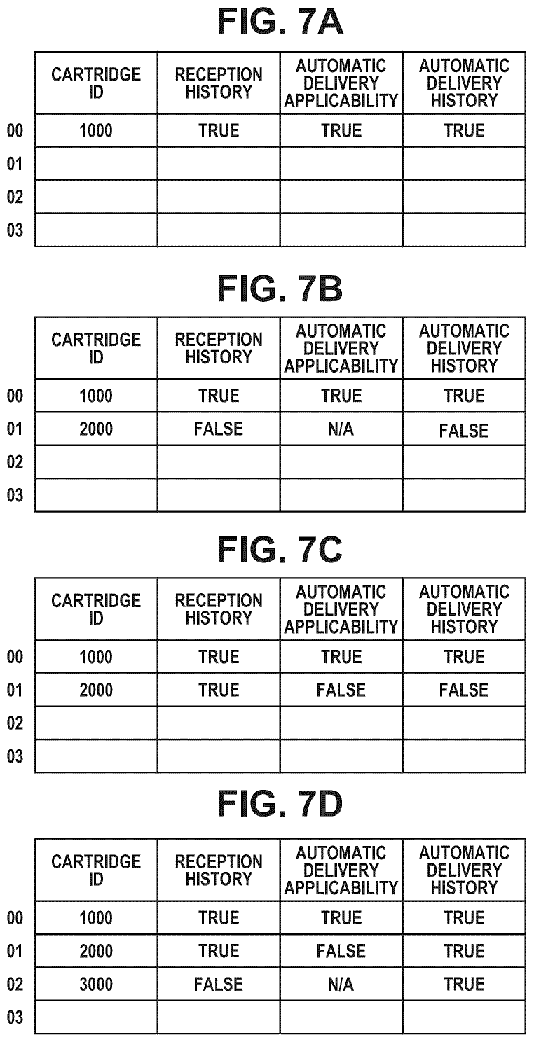

FIGS. 7A to 7D are diagrams each illustrating a configuration example of data stored in the storage unit 14 of the image forming apparatus 1. According to the present exemplary embodiment, the storage unit 14 stores the cartridge ID (consumable identification information) and service-related information in associated way. The storage unit 14 stores a plurality of these associated records. The storage unit 14 stores information (reception history) indicating whether the image forming apparatus 1 has received the automatic delivery applicability information as the service-related information. The storage unit 14 stores the automatic delivery applicability information on the ink cartridge 5 serving as a target as the service-related information. Further, the storage unit 14 stores the automatic delivery history information on a target which is the ink cartridge 5, as the service-related information. According to the present exemplary embodiment, the control unit 11 performs control for storing the service-related information by storage unit 14.

According to the present exemplary embodiment, the storage unit 14 separately manages information on the black cartridge 51 and the color cartridge 52. More specifically, a database for managing the information on the color cartridge 52 and a database for managing the information on the black cartridge 51 are separately established in the storage unit 14. The configuration of the storage unit 14 is not limited thereto. For example, information on a plurality of different types of the ink cartridges 5 may be collectively managed.

Referring to FIGS. 7A to 7D, “TRUE” in the reception history indicates that the automatic delivery applicability information on the cartridge identified by a target cartridge ID has been received. “FALSE” in the reception history indicates that the automatic delivery applicability information on the cartridge identified by the target cartridge ID has not been received.

“TRUE” in the automatic delivery applicability information indicates that the cartridge identified by the target cartridge ID corresponds to an automatically delivered cartridge. “FALSE” in the automatic delivery applicability information indicates that the cartridge identified by the target cartridge ID does not correspond to an automatically delivered cartridge. “N/A” in the automatic delivery applicability information indicates that the automatic delivery applicability information is not available because the cartridge identified by the target cartridge ID has not received the automatic delivery applicability information.

“TRUE” in the automatic delivery history indicates that the management server 2 has transmitted a delivery request for the cartridge identified by the target cartridge ID (delivery history is present). “FALSE” in the automatic delivery history indicates that the management server 2 has not transmitted a delivery request for the cartridge identified by the target cartridge ID (no delivery history is present). More specifically, the automatic delivery history is information indicating whether the automatic consumable delivery service has performed the delivery processing for the cartridge identified by the target cartridge ID.

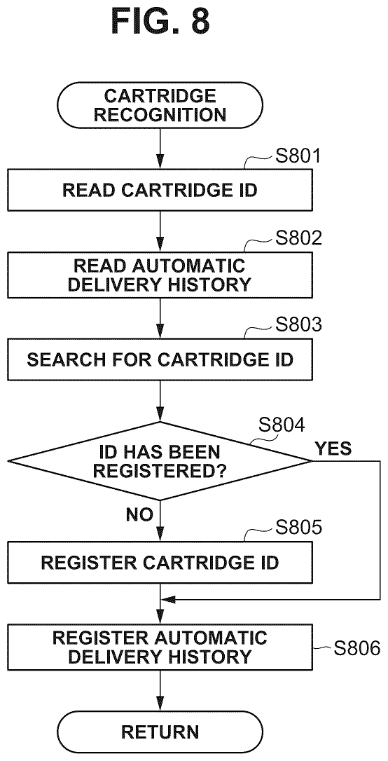

FIGS. 8 to 10 are flowcharts illustrating detailed control of the image forming apparatus 1. Processing executed by the control unit 11 of the image forming apparatus 1 will be described in detail below with reference to FIGS. 7A to 7D and FIGS. 8 to 10. The flowcharts in FIGS. 8 to 10 are implemented by the CPU 111 of the control unit 11 of the image forming apparatus 1 reading a program stored in the ROM 113 into the RAM 112 and then executing the program.

FIG. 8 is a flowchart illustrating an example of the cartridge recognition processing, i.e., detailed processing in step S611 in FIG. 6A.

In step S801, the control unit 11 reads the cartridge ID of an ink cartridge 5 attached to the consumable attachment unit 16. For example, the control unit 11 reads the cartridge IDs stored in the nonvolatile memory 512 of the black cartridge 51 and the nonvolatile memory 522 of the color cartridge 52 via the reading/writing unit 15. The control unit 11 stores the cartridge IDs read via the reading/writing unit 15 into the RAM 112.

In step S802, the control unit 11 reads the automatic delivery history information on an ink cartridge 5 attached to the consumable attachment unit 16. For example, like step S801 described above, the control unit 11 reads the automatic delivery history information stored in the nonvolatile memories 512 and 522. The control unit 11 stores the automatic delivery history information read by the reading/writing unit 15 into the RAM 112.

In step S803, the control unit 11 determines whether the cartridge ID read in step S801 and stored in the RAM 112 is stored in the storage unit 14.

In step S804, the control unit 11 performs control of branch processing based on the result of the search in step S803. In a case where the cartridge ID read in step S801 is not stored in the storage unit 14, i.e., the cartridge ID has not been registered (NO in step S804), the processing proceeds to step S805.

In step S805, the control unit 11 stores (registers) the cartridge ID read in step S801 in the storage unit 14. Then, the processing proceeds to step S806.

In a case where the cartridge ID read in step S801 has been stored in the storage unit 14, i.e., the cartridge ID has been registered (YES in step S804), the processing proceeds to step S806.

In step S806, the control unit 11 stores (registers) the automatic delivery history information read in step S802 in the storage unit 14 in association with the cartridge ID. Then, the processing exits this flowchart.

A processing flow for registration of the cartridge ID and the automatic delivery history information based on the flowchart in FIG. 8 will be described below with reference to a specific example.

In the following descriptions, data regarding the black cartridge 51 stored in the storage unit 14 is in the status illustrated in FIG. 7A. In the following descriptions, the flowchart in FIG. 8 is started when the black cartridge 51 having the cartridge ID “2000” and the automatic delivery history information “FALSE” is attached to the consumable attachment unit 16.

In step S801, the control unit 11 reads the cartridge ID of the black cartridge 51 attached to the consumable attachment unit 16 via the reading/writing unit 15. In step S802, the control unit 11 reads the automatic delivery history information. In step S803, the control unit 11 searches for the read cartridge ID (2000) to determine whether the cartridge ID has been stored in the storage unit 14. Since the cartridge ID has not been stored in the storage unit 14 (NO in step S804), the processing proceeds to step S805. In step S805, the control unit 11 registers the cartridge ID. More specifically, as illustrated in FIG. 7B, the control unit 11 registers the cartridge ID “2000” to a new region in the storage unit 14. In this state, the image forming apparatus 1 has not received a response indicating whether the black cartridge 51 is an automatically delivered cartridge from the management server 2. Therefore, with respect to the ID, the control unit 11 stores “FALSE” in the reception history information and “N/A” in the automatic delivery applicability information, in the storage unit 14. In step S806, the control unit 11 stores read information, i.e., the automatic delivery history information “FALSE”, in the storage unit 14 in association with the cartridge ID (2000).

With the above-described processing, in a case where the cartridge ID of the ink cartridge 5 attached to the consumable attachment unit 16 is not the one stored in the storage unit 14, the cartridge ID is stored in the storage unit 14. The automatic delivery history information stored in the ink cartridge 5 is also stored in the storage unit 14.

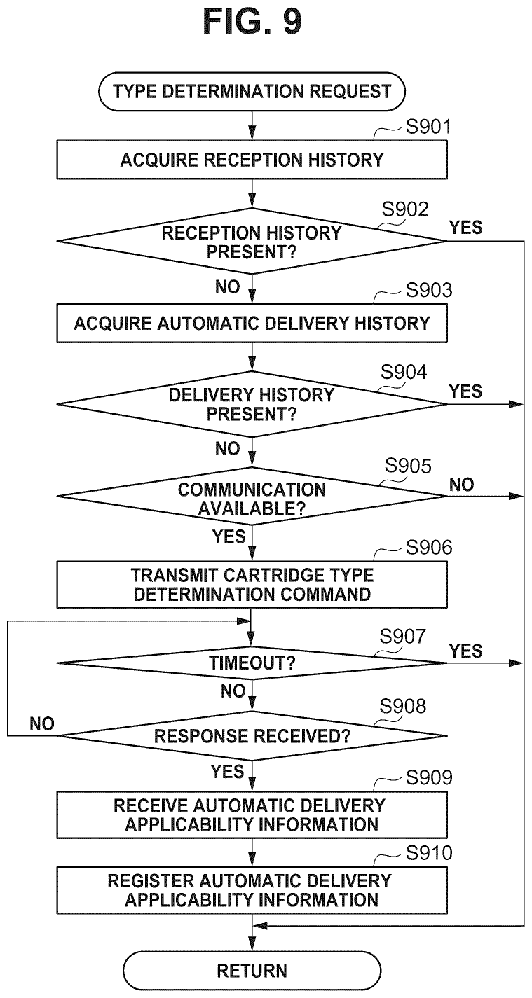

FIG. 9 is a flowchart illustrating an example of the cartridge type determination request processing, i.e., the detail processing in step S612 in FIG. 6A.

In step S901, the control unit 11 checks the reception history of a response to a cartridge type determination request. For example, the control unit 11 reads the above-described cartridge ID read in step S801 in FIG. 8 from the RAM 112. Then, from the storage unit 14, the control unit 11 acquires the automatic delivery applicability information on the read cartridge ID, i.e., whether the reception history for a response to the cartridge type determination request is present.

For example, the cartridge ID “1000” has been stored in the RAM 112, and the data regarding the ink cartridge 5 having the cartridge ID “1000” stored in the storage unit 14 is in a status as illustrated in FIG. 7B. In this case, the cartridge ID “1000” has the reception history information “TRUE” indicating that a response to the cartridge type determination request has been received. Thus, the control unit 11 recognizes that the ink cartridge 5 having the cartridge ID “1000” has received a response to the cartridge type determination request, i.e., the reception history is present.

For example, the cartridge ID “2000” has been stored in the RAM 112, and the data regarding the ink cartridge 5 having the cartridge ID “2000” stored in the storage unit 14 is in a status as illustrated in FIG. 7B. In this case, the cartridge ID “2000” has the reception history information “FALSE” indicating that a response to the cartridge type determination request has not been received.

Therefore, the control unit 11 recognizes that the ink cartridge 5 having the cartridge ID “2000” has not received a response to the cartridge type determination request, i.e., the reception history is absent.

In step S902, the control unit 11 performs control of branch processing based on the result of the confirmation in step S901.

In a case where the control unit 11 has acquired the reception history in step S901, i.e., the control unit 11 recognizes that the reception history is present (YES in step S902), the processing exits this flowchart. More specifically, in a case where a response result to the cartridge type determination request has been stored in the storage unit 14, the control unit 11 does not transmit a cartridge type determination command to the management server 2 (processing in step S906 to be described below). This reduces the load on the management server 2.

in a case where the control unit 11 has not acquired the reception history in step S901, i.e., the control unit 11 recognizes that the reception history is absent (NO in step S902), the processing proceeds to step S903.

In step S903, the control unit 11 checks the automatic delivery history information. For example, like step S901 described above, the control unit 11 reads the cartridge ID from the RAM 112. Then, from the storage unit 14, the control unit 11 acquires the automatic delivery history information on the read cartridge ID.

A description is given of an example case in which the cartridge ID “1000” has been stored in the RAM 112, and the data regarding the ink cartridge 5 having the cartridge ID “1000” stored in the storage unit 14 is in a status as illustrated in FIG. 7B. The cartridge ID “1000” has the automatic delivery history information “TRUE”. Thus, for the ink cartridge 5 having the cartridge ID “1000”, the control unit 11 recognizes that the management server 2 has transmitted a delivery request (the delivery history is present).

A description is given of another example case in which the cartridge ID “2000” has been stored in the RAM 112, and the data regarding the ink cartridge 5 having the cartridge ID “2000” stored in the storage unit 14 is in a status as illustrated in FIG. 7B.The cartridge ID “2000” has the automatic delivery history information “FALSE”. Thus, for the ink cartridge 5 having the cartridge ID “2000”, the control unit 11 recognizes that the management server 2 has not transmitted a delivery request (the delivery history is absent).

In step S904, the control unit 11 performs control of branch processing based on the result of the checking in step S903.

In a case where the control unit 11 has acquired the delivery history in step S903, i.e., the control unit 11 recognizes that the delivery history is present (YES in step S904), the processing exits this flowchart. More specifically, in a case where the management server 2 has already transmitted a delivery request, the control unit 11 skips transmission of a cartridge type determination command to the management server 2 (processing in step S906 to be described below). This reduces the load on the management server 2.

In a case where the control unit 11 has not acquired the delivery history in step S903, i.e., the control unit 11 recognizes that the delivery history is absent (NO in step S904), the processing proceeds to step S905. More specifically, in a case where the management server 2 has not transmitted a delivery request, the control unit 11 transmits a cartridge type determination command to the management server 2 (processing in step S906 to be described below).

According to the present exemplary embodiment, the management server 2 transmits a delivery request once for each of the ink cartridge 5. Thus, in a case where the automatic delivery history information indicates that the delivery history is present, the management server 2 does not transmit a delivery request again. As for the ink cartridge 5 with which the delivery history is present, the control unit 11 determines that the transmission of a cartridge type determination command to the management server 2 is not to be performed, and thus processing in step S906 (transmission of a cartridge type determination command to the management server 2) is omitted.

In a case where neither the reception history nor the automatic delivery history information is present for either one or both of the black cartridge 51 and the color cartridge 52, the control unit 11 may execute the processing in step S905 and subsequent steps for the ink cartridge 5. Alternatively, the control unit 11 may separately execute the flowchart illustrated in FIG. 9 for each of the black cartridge 51 and the color cartridge 52.

In step S905, the control unit 11 performs control of branch processing according to whether communication between the communication unit 12 of the image forming apparatus 1 and the management server 2 is available.

In a case where communication between the communication unit 12 and the management server 2 is not available (NO in step S905), the processing exits the flowchart.

In a case where communication between the communication unit 12 and the management server 2 is available (YES in step S905), the processing proceeds to step S906.

In step S906, the control unit 11 transmits a cartridge type determination command to the management server 2 via the communication unit 12. In this case, the control unit 11 transmits the cartridge ID of the ink cartridge 5 together with the command to the management server 2.

Then, the control unit 11 waits in steps S907 and S908 until the communication unit 12 receives a response to the cartridge type determination command from the management server 2.

In step S907, the control unit 11 determines whether the waiting state since the command transmission lasts for a predetermined time duration or longer, i.e., whether the waiting state times out.

In a case where the waiting state since the command transmission times out (YES in step S907), the control unit 11 exits the above-described waiting state, and the processing exits this flowchart.

In a case where the waiting state since the command transmission does not time out (NO in step S907), the processing proceeds to step S908.

In step S908, the control unit 11 determines whether a response has been received from the management server 2 via the communication unit 12.

In a case where no response has been received from the management server 2 via the communication unit 12 (NO in step S908), the processing returns to step S907.

Based on the load condition of the management server 2, a delay may occur in an operation time since the command transmission till the response reception. Thus, after transmitting a cartridge type determination command, the control unit 11 repeats the processing in steps S907 and S908 to keep waiting for the response reception from the management server 2 until the waiting state times out (e.g., for one minute since the command transmission).

In a case where a response has been received from the management server 2 via the communication unit 12 (YES in step S908), the processing proceeds to step S909.

In step S909, the control unit 11 receives the automatic delivery applicability information from the management server 2 via the communication unit 12. In this way, the control unit 11 of the image forming apparatus 1 checks the automatic delivery applicability information which is an example of the service-related information on the consumable attached to the consumable attachment unit 16, via the communication unit 12 for communication with the management server 2 serving as an external apparatus.

In step S910, the control unit 11 stores (registers) the information received in step S909 in association with the cartridge ID acquired in step S901, and updates the corresponding reception history information to “TRUE” indicating that the information has been received. Then, the processing exits this flowchart.

A description will be given of an example case in which the data regarding the ink cartridge 5 having the cartridge ID “2000” stored in the storage unit 14 is in a status as illustrated in FIG. 7B. The communication unit 12 has received information indicating that the ink cartridge 5 having the cartridge ID “2000” is not an automatically delivered cartridge. In this case, as illustrated in FIG. 7C, the control unit 11 registers the automatic delivery applicability information “FALSE” indicating that the ink cartridge 5 is not an automatically delivered cartridge, to a predetermined position in the storage unit 14 as information about the cartridge ID “2000”. The control unit 11 updates the reception history information on the cartridge ID “2000” registered to the predetermined position in the storage unit 14 to “TRUE” indicating that the automatic delivery applicability information has been received.

Example cases where the ink cartridge 5 is not an automatically delivered cartridge include a case where the user of the image forming apparatus 1 does not contract the automatic delivery service of the ink cartridge 5. In other example cases, even though the user of the image forming apparatus 1 contracts the automatic delivery service, the user purchases an ink cartridge 5 commercially available for a certain reason, and attaches the ink cartridge 5 to the consumable attachment unit 16. According to the present exemplary embodiment, in such a case, the control unit 21 of the management server 2 determines that the automatic delivery of the ink cartridge 5 is not to be performed, in response to receipt of the cartridge delivery determination command.

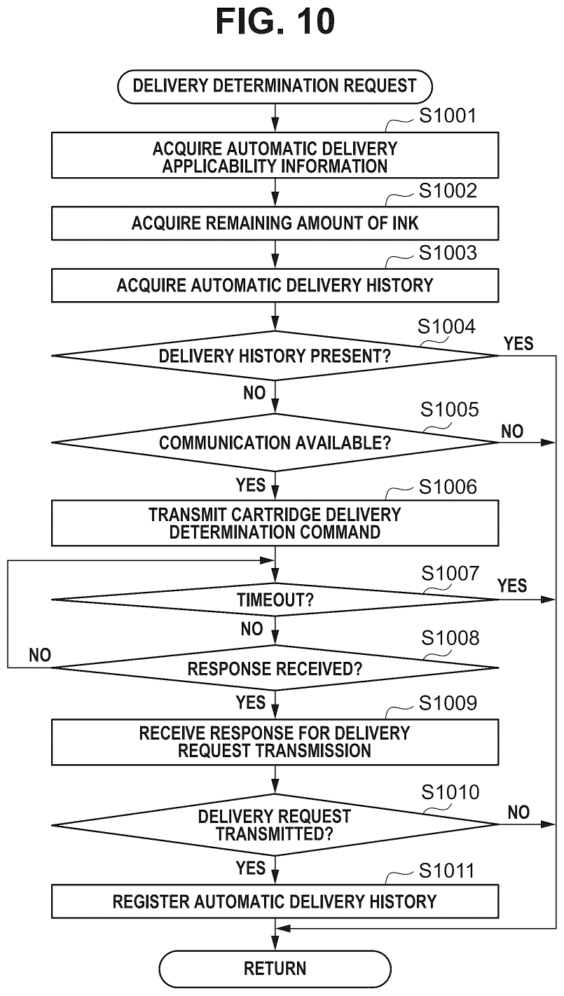

FIG. 10 is a flowchart illustrating delivery determination request processing, i.e., specific processing in step S613 in FIG. 6A.

In step S1001, the control unit 11 acquires the automatic delivery applicability information. From the RAM 112, the control unit 11 reads the cartridge ID read in step S801 in FIG. 8. Then, the control unit 11 acquires the automatic delivery applicability information on the read cartridge ID from the storage unit 14.

A description is given of an example case in which the cartridge ID “1000” has been stored in the RAM 112, and the data regarding the ink cartridge 5 having the cartridge ID “1000” stored in the storage unit 14 is in a status as illustrated in FIG. 7C. In this case, since the cartridge ID “1000” has the automatic delivery applicability information “TRUE”, the control unit 11 identifies that the ink cartridge 5 having the cartridge ID “1000” is an automatically delivered cartridge.

In step S1002, the control unit 11 acquires the remaining amount of ink in the ink cartridge 5. The remaining amount of ink in the ink cartridge 5 may be estimated, for example, based on the number of ink discharges (dot count) at the time of image recording performed by the printing unit 13. The method for estimating the remaining amount of ink is not limited thereto. For example, the remaining amount of ink may be physically detected with a sensor for electrically detecting ink, for example, by using electrode pins.

In step S1003, the control unit 11 checks the automatic delivery history information by using a method similar to the one in step S903 in FIG. 9.

The control unit 11 performs control of branch processing in step S1004 based on the result of the checking in step S1003.

In a case where the control unit 11 has acquired the automatic delivery history information in step S1003, i.e., the control unit 11 recognizes that the delivery history is present (YES in step S1004), the processing exits this flowchart. More specifically, in a case where the management server 2 has already transmitted a delivery request, the control unit 11 skips transmission of a cartridge delivery determination command to the management server 2 (see step S1006 to be described below). This reduces the load on the management server 2.

In a case where the control unit 11 has not acquired the automatic delivery history information in step S1003, i.e., the control unit 11 recognizes that the delivery history is absent (NO in step S1004), the processing proceeds to step S1005.

According to the present exemplary embodiment as described above, in a case where the automatic delivery history information indicates that the delivery history is present, the management server 2 does not transmit a delivery request again. Thus, as for the ink cartridge 5 with which the delivery history is present, the control unit 11 determines that the transmission of a cartridge delivery determination command to the management server 2 is unnecessary, whereby transmission of a cartridge type determination command to the management server 2 (see step S1006 to be described below) is skipped.

In a case where the delivery history is absent for either one or both of the black cartridge 51 and the color cartridge 52, the control unit 11 may execute the processing in step S1005 and subsequent steps for the ink cartridge 5. Alternatively, the control unit 11 may separately execute the flowchart illustrated in FIG. 10 for each of the black cartridge 51 and the color cartridge 52.

In step S1005, the control unit 11 performs control of branch processing according to whether communication between the communication unit 12 of the image forming apparatus 1 and the management server 2 is available.

In a case where communication between the communication unit 12 and the management server 2 is not available (NO in step S1005), the processing exits the flowchart.

In a case where communication between the communication unit 12 and the management server 2 is available (YES in step S1005), the processing proceeds to step S1006.

In step S1006, the control unit 11 transmits a cartridge delivery determination command to the management server 2 via the communication unit 12. In this processing, the control unit 11 also transmits the automatic delivery applicability information on the ink cartridge 5 acquired in step S1001 and the remaining amount of ink in the ink cartridge 5 acquired in step S1002 to the management server 2.

A description is given of a case where the cartridge ID “2000” has been stored in the RAM 112, and the data regarding the ink cartridge 5 having the cartridge ID “2000” stored in the storage unit 14 is in a status as illustrated in FIG. 7C will be described below. In this case, since the control unit 11 identifies that the automatic delivery applicability information is “FALSE” in step S1001, the control unit 11 transmits information indicating that the ink cartridge 5 having the cartridge ID “2000” is not an automatically delivered cartridge, to the management server 2 in step S1006. In this case, the control unit 21 of the management server 2 determines that delivery is not to be performed (delivery request is not performed) in step S532 in FIG. 5C.

According to the present exemplary embodiment, even in a case where the automatic delivery applicability information acquired in step S1001 is “FALSE”, the control unit 11 transmits a cartridge delivery determination command to the management server 2. In this case, however, the transmission of a cartridge delivery determination command is omittable and thus step S1006 may be skipped. This further reduces the load on the management server 2.

In steps S1007 to S1008, the control unit 11 repeats processing similar to the processing in steps S907 to S908 in FIG. 9, respectively, to keep waiting for the response reception from the management server 2 until the waiting state times out.

In a case where the waiting state since the command transmission times out (YES in step S1007), the control unit 11 exits the waiting state, and the processing exits this flowchart.

In a case where a response has been received from the management server 2 via the communication unit 12 (YES in step S1008), the processing proceeds to step S1009.

In step S1009, from the management server 2 via the communication unit 12, the control unit 11 receives a response indicating whether the management server 2 has transmitted a delivery request.

In step S1010, the control unit 11 controls branch processing based on the result of the response reception in step S1009.

In a case where the control unit 11 receives a response indicating that the management server 2 does not transmit a delivery request in step S1009 (NO in step S1010), the processing exits this flowchart.

In a case where the control unit 11 receives a response indicating that the management server 2 has transmitted a delivery request in step S1009 (YES in step S1010), the processing proceeds to step S1011.

In step S1011, the control unit 11 stores (registers) the automatic delivery history information indicating that delivery history is present, in association with the above-described the cartridge ID. More specifically, the control unit 11 updates the automatic delivery history information stored in the storage unit 14 to “TRUE” in association with the above-described cartridge ID. After completion of the processing in step S1011, the processing exits this flowchart.

A description will be given of an example case in which the data regarding the ink cartridge 5 having the cartridge ID “2000” stored in the storage unit 14 is in a status as illustrated in FIG. 7C. Then, the communication unit 12 has received information indicating that the automatic delivery has been requested for the ink cartridge 5 having the cartridge ID “2000”. In this case, as illustrated in FIG. 7D, the control unit 11 updates the automatic delivery history of the cartridge ID “2000” registered to the predetermined position of the storage unit 14 to “TRUE” indicating that the management server 2 has transmitted a delivery request.

According to the present exemplary embodiment, in a case where the control unit 11 executes the processing in FIG. 6C, the automatic delivery history stored in the storage unit 14 in step S1011 is reflected to the nonvolatile memory 512 or 522 of the ink cartridge 5 in the cartridge update processing in step S631.

More specifically, the control unit 11 updates the automatic delivery history information stored in the ink cartridge 5 via the reading/writing unit 15. The timing when the control unit 11 updates the automatic delivery history information stored in the ink cartridge 5 is not limited thereto and may be immediately after completion of step S1011 in FIG. 10. With the automatic delivery history stored in the ink cartridge 5 in this way, the automatic delivery history is retained even in a case where the user detaches the ink cartridge 5 from the consumable attachment unit 16 and then attaches the ink cartridge 5 to the consumable attachment unit of another image forming apparatus.

While, in the present exemplary embodiment, the control unit 11 receives a response to the cartridge delivery determination command from the management server 2 and manages the automatic delivery history information based on the result of the response, the method for managing the automatic delivery history information is not limited thereto. Examples of history information to be managed may include history information about the detection of a small remaining amount of ink in the ink cartridge 5. History information to be managed may include information irrelevant to the automatic consumable delivery service. Example of history information to be managed may include history information about the image recording performed on a recording medium by the printing unit 13 in a state where the ink cartridge 5 is attached to the consumable attachment unit 16 of the image forming apparatus 1.

According to the present exemplary embodiment, the control unit 11 reads the automatic delivery history information on the ink cartridge 5 in step S802 in FIG. 8 and stores the information in the storage unit 14 in association with the cartridge ID in step S806 in FIG. 8. Then, the control unit 11 acquires the automatic delivery history information from the storage unit 14 in step S903 in FIG. 9, and in a case where the control unit 11 recognizes that the delivery history is present, the control unit 11 skips transmission of a cartridge type determination command to the management server 2 in step S906.

For example, the control unit 11 executes the processing illustrated in FIG. 6B in response to the user attaching an ink cartridge 5 to the consumable attachment unit 16, where the ink cartridge 5 has been attached to the consumable attachment unit of another image forming apparatus, and the management server 2 has transmitted a delivery request while the cartridge has been attached to the consumable attachment unit. In this case, the control unit 11 recognizes that the delivery history is present in step S903 in FIG. 9 and skips transmission of a cartridge type determination command in step S906. This reduces the load on the management server 2.

As yet another example, in a case where the control unit 11 executes the processing illustrated in FIG. 6B in response to the user attaching the ink cartridge 5 having no delivery history to the consumable attachment unit 16 in a state where communication between the communication unit 12 of the image forming apparatus 1 and the management server 2 is not available, the result of the step S905 in FIG. 9 is NO, which means that the control unit 11 cannot transmit a cartridge type determination command to the management server 2 in step S906. Then, when communication between the communication unit 12 and the management server 2 is available, the control unit 11 executes the processing of the flowchart illustrated in FIG. 6D. In this case, the control unit 11 acquires the automatic delivery history information pre-stored in the storage unit 14 in step S903, whereby the control unit 11 transmits a cartridge type determination command in step S906 while the load on the management server 2 is reduced. Also, a cartridge delivery determination command to the management server 2 is subsequently transmitted in step S1006 in FIG. 10, the automatic delivery service for the ink cartridge 5 is smoothly provided.

Although the above-described exemplary embodiment uses ink cartridges as examples of consumables, other forms are also applicable. For example, in a case where the image forming apparatus 1 is an electrophotographic printer, toner may be an example of a consumable. More specifically, consumables may be recording agents other than ink cartridges. Alternatively, in addition to recording agents, any other consumables may be used.

The processing of the image forming apparatus 1 illustrated in FIGS. 6A to 6D and FIGS. 8 to 10 according to the exemplary embodiment may be set to be executable in response to updating of the control program of the image forming apparatus 1 having the communication unit 12 and the consumable attachment unit 16. For example, when a service provider makes a contract with a contractor, the control program of the image forming apparatus owned by the contractor or the image forming apparatus leased to the contractor may be updated. With this processing, the consumable management system SY is established and the automatic consumable delivery service is operated.

Although, according to the exemplary embodiment, the image forming apparatus 1 includes the control unit 11 and the communication unit 12, other forms are also applicable. For example, a communication apparatus having the communication unit 12 and a control unit capable of executing the processing illustrated in FIGS. 6A to 6D and FIGS. 8 to 10 may be connected with an image forming apparatus including the consumable attachment unit 16 so that the above-described processing may be executed by the image forming apparatus. In this case, by connecting the communication apparatus with the image forming apparatus owned by the contractor of the contract or the image forming apparatus leased to the contractor, the consumable management system SY is established and the automatic consumable delivery service is operated.

In the prior art, the management server is heavily loaded since the entire determination of whether a consumable is a target of the automatic delivery service is performed by the management server. According to the present exemplary embodiment, in a case where determination is performable in the printing apparatus by using the information in the memory of the consumable, the determination in the server is skipped, which reduces the load on the management server. However, there arises an issue that the printing apparatus may not be able to immediately make an inquiry to the management server at the timing when the memory of the consumable is accessed.

For example, there may be a case that communication with the management server 2 may not have been established at the timing. According to the present exemplary embodiment, the information read from the memory of the consumable at the timing when the memory of the consumable is accessible is stored (registered) in the memory of the printing apparatus main body. Then, by using the information stored in the printing apparatus main body, the printing apparatus determines whether the consumable is a target of the automatic delivery service, for example, at the timing when communication with the management server 2 is established. With this configuration, even in a case where the timing when the memory of the consumable is accessible is different from the timing when communication with the management server is available, the printing apparatus is able to determine whether an inquiry to the management server is to be performed. Accordingly, even in a case where communication with the management server 2 is not available when the printing apparatus accesses the memory of the consumable, for example, the printing apparatus is able to promptly determine whether the consumable is a target of the automatic delivery service when communication with the management server is available at a subsequent timing. This configuration utilizes both the determination by the printing apparatus and the determination by the management server, which reduces load on the management server in the automatic consumable delivery.

According to the present disclosure, the load on the server is reduced in the automatic consumable delivery.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-019941, filed Feb. 14, 2024, which is hereby incorporated by reference herein in its entirety.

What is claimed is:

1. A printing apparatus comprising:
a first processing unit configured to execute first processing for reading, from a first storage unit of a consumable attached to the printing apparatus, identification information on the consumable and history information indicating whether delivery processing has been executed by a predetermined service for the consumable identified by the identification information, and storing the identification information and the history information in a second storage unit of the printing apparatus;
a requesting unit configured to request relating information on the predetermined service for the consumable attached to the printing apparatus to a server system that provides the predetermined service; and
a reception unit configured to receive the relating information on the predetermined service transmitted from the server system in response to the request,
wherein the request is not transmitted in a case where the history information includes a delivery history indicating that delivery processing has been executed by the predetermined service, and the request is transmitted in a case where the history information stored in the second storage unit in association with the identification information on the consumable attached to the printing apparatus indicates that the delivery processing has not been executed by the predetermined service.

2. The printing apparatus according to claim 1, wherein the first processing is executed in at least either one of a case where the printing apparatus is activated and a case where a consumable is attached to the printing apparatus.

3. The printing apparatus according to claim 1, further comprising a second processing unit configured to execute, in response to receipt of information indicating that delivery processing has been executed by the predetermined service for a consumable identified by identification information on the consumable attached to the printing apparatus as relating information on the predetermined service, second processing for updating the history information stored in the second storage unit in association with the identification information on the consumable attached to the printing apparatus to information indicating that delivery processing has been executed by the predetermined service.

4. The printing apparatus according to claim 3, further comprising a third processing unit configured to execute third processing for updating the history information stored in the first storage unit of the consumable attached the printing apparatus, based on the history information stored in the second storage unit in association with the identification information on the consumable attached to the printing apparatus.

5. The printing apparatus according to claim 4, wherein the third processing is executed in at least either one of a case where the second processing is executed and a case where printing is performed by the printing apparatus.

6. A method for controlling a printing apparatus comprising:
reading, from a first storage unit of a consumable attached to the printing apparatus, identification information on the consumable and history information indicating whether delivery processing has been executed by a predetermined service for the consumable identified by the identification information, and storing the identification information and the history information in a second storage unit of the printing apparatus;
transmitting a request for relating information on the predetermined service for the consumable attached to the printing apparatus to a server system that provides the predetermined service; and
receiving the relating information on the predetermined service transmitted from the server system in response to the request,
wherein the request is not transmitted in a case where the history information includes a delivery history indicating that delivery processing has been executed by the predetermined service, and the request is transmitted in a case where the history information stored in the second storage unit in association with the identification information on the consumable attached to the printing apparatus indicates that the delivery processing has not been executed by the predetermined service.
